(19) United States
(12) Patent Application Publication
(10) Pub. No.: US 2026/0077330 A1
(43) Pub. Date: Mar. 19, 2026

(54) MICROENCAPSULATION OF RUBBER- AND POLYMER-MODIFIED BITUMEN FOR STORAGE AND TRANSPORTATION

(71) Applicants: THE TEXAS A&M UNIVERSITY SYSTEM, COLLEGE STATION, TX (US); PUMA ENERGY SUPPLY & TRADING PTE. LTD., ALTONA MEADOWS (AU)

(72) Inventors: FNU ANITA, COLLEGE STATION, TX (US); ERIK DENNEMAN, ALTONA MEADOWS (AU); SARBAJIT BANERJEE, COLLEGE STATION, TX (US)

(21) Appl. No.: 19/331,112

(22) Filed: Sep. 17, 2025

Related U.S. Application Data
(60) Provisional application No. 63/695,445, filed on Sep. 17, 2024.

(51) Int. Cl. B01J 13/10; C08L 53/02; C08L 95/00

(52) U.S. Cl. CPC B01J 13/10; C08L 53/02; C08L 95/00; C08L 2205/035; C08L 2205/20

(57) ABSTRACT

The subject invention pertains to compositions and methods of encapsulating bitumen for storage and transportation. More specifically, the capsule surrounding bitumen can contain electrolyte layers, bound through electrostatic interactions, on the surface of bitumen.

### CROSS-REFERENCE TO A RELATED APPLICATION

This application claims the benefit of U.S. Provisional Application Ser. No. 63/695,445, filed Sep. 17, 2024, the disclosure of which is hereby incorporated by reference in its entirety, including all figures, tables and amino acid or nucleic acid sequences.

### BACKGROUND OF THE INVENTION

Extensive worldwide expansion of transportation infrastructure, increased intensity of roadway use, massive global increases in the use of trucking for cargo shipments, and the introduction of radial tires have stretched performance demands on conventional asphalt materials to the limit. As such, the last several decades have seen an intense focus on modification of asphalt with small-molecule, macromolecular, or condensed-phase additives as a means of improving the viscoelastic properties of asphalt binders and prolonging pavement life.¹⁻³ Some examples of additives incorporated within bitumen binders include elastomeric and plastomeric macromolecules, surfactants, zeolites, long-chain aliphatic amides, and amines.⁴⁻¹⁰ Conventional asphalt construction is based on admixtures comprising 6-12 vol. % bituminous hydrocarbons, which bind the mixture together and serve as viscoelastic water impermeable sealants; 84-90 vol. % mineral aggregates, such as rocks, sand, and gravel, which imbue load-bearing properties, interspersed with about 4 vol. % air voids.¹¹ Conventional asphalt mixtures often struggle to meet durability and performance requirements under relatively modest excursions from standard loading conditions. For instance, conventional bitumen-based asphalt pavements are prone to thermal fatigue and cracking as a result of temperature variations.¹²⁻¹⁴ Indeed, high daytime temperatures engender decreased shear resistance, which, under traffic loading, can give rise to flow and severe plastic deformation of the pavement. Conversely, at low temperatures, accumulation of tensile stress leads to crack initiation and propagation.¹⁵ In addition to fatigue resulting from temperature variations, exposed road surfaces are also prone to oxidative aging and corrosion.^{13,16-18} Much attention has focused on the incorporation of additives to alleviate pavement distress. Specifically, polymer-modified bitumen¹⁹⁻²¹ and waste-tire-rubber-modified bitumen^{22,23} have attracted substantial recent attention. The high elastic moduli of the incorporated additives facilitate stress dissipation upon loading, and render the composite significantly more deformable under temperature variations, thereby substantially alleviating fatigue and fracture. Select additives can further imbue protection against aging and oxidation, reduce traffic noise, and decrease pavement maintenance costs, while also serving as a means of sequestering waste tire residues.²²⁻²⁶ However, as observed with the midstream transportation of bitumen,²⁷ the handling and transportation of modified bitumen binders poses a substantial challenge, and has been a substantial constraint to expanding roadways infrastructure in emerging economies. Modified binder mixtures are constantly exposed to high temperatures during storage and transportation, which results in thermal degradation and aging.²⁸⁻³² In addition to the loss of material from fouling of container surfaces and downtime associated with cleaning, transportation and storage of binders necessitates deployment of an extensive thermal jacketing infrastructure.³³ Furthermore, crumb-rubber inclusions blended within the bituminous mixture tend to phase segregate upon prolonged storage.²⁸

Polymer- and waste-tire-rubber-modified bitumen can be used in asphalt construction, since the high elastic moduli of the incorporated additives engenders improved stress dissipation, thereby substantially alleviating pavement fatigue and fracture. In addition to imbuing resistance to aging and oxidation, reducing traffic noise, and decreasing pavement maintenance costs, such additives serve as a means of sequestering polymer waste. Previously, the storage and transportation of modified bitumen posed a challenge, since exposure to high temperatures can accelerate thermal degradation, phase segregation, and aging. Transportation of modified bitumen typically requires extensive thermal jacketing to overcome the challenging rheological characteristics of the material and incurs substantial product losses from fouling of containers. Thus, novel methods of transporting and storing polymer- and rubber-modified bitumen are needed to address the needs of the industry.

### BRIEF SUMMARY OF THE INVENTION

The subject invention pertains to a versatile microencapsulation strategy to enable the solid-phase storage and transportation of viscoelastic bitumen. Upon microencapsulation, bitumen, including, for example, polymer-modified bitumen (PMB) and rubber-modified bitumen (RMB), can be transformed into microdroplets encapsulated within cross-linked shells. This enables the transportation of bitumen as millimeter-sized prills, alleviating the considerable rheological challenges associated with direct handling of bitumen while providing a readily reversible method to recover the preserved modified bitumen through mechanical compression or thermal treatment.

In certain embodiments, the viscoelastic bitumen can be encapsulated in a shell comprising lignosulfonate and/or salts thereof, alkali lignin, and/or alkaline lignin and a material such as hydrated lime or the like. In preferred embodiments, alkali lignin, alkaline lignin and/or salts of lignosulfonate such as sodium, calcium, magnesium, ammonium salts can be used. With respect to the materials, Ca(OH)₂ (i.e., hydrated lime) or other materials can be used, such as calcium oxide, magnesium hydroxide, magnesium oxide, barium hydroxide, barium oxide, strontium hydroxide, strontium oxide, baralyme (BaCaH₅KO₅), soda lime, as well as oxides of silicon, aluminum, iron and calcium (such as pozzolans and fly ash), and siliceous and/or siliceous and aluminous materials from pure materials and/or naturally-sourced materials (for example, volcanic ash, pumice, opaline shales, burnt clay) are used as shell materials to encapsulate the viscoelastic bitumen. In order to encapsulate bitumen, a lignosulfonate polyanionic electrolyte is alternated with a cationic polyelectrolyte, such as, for example, poly(diallyl dimethylammonium chloride)) (PDAC), through a layer-by-layer assembly process. In certain embodiments, hydrated lime or other materials, such as calcium oxide, magnesium hydroxide, magnesium oxide, barium hydroxide, barium oxide, strontium hydroxide, strontium oxide, Baralyme (BaCaH5KO5), soda lime, oxides of silicon, aluminum, iron and calcium, pozzolans, fly ash, volcanic ash, pumice, opaline shales, burnt clay, or combinations thereof, can be incorporated as a precursor to the layering process, during the layering process, and/or after the layering process to promote precipitation of CaCO₃ (e.g., calcite, aragonite, and/or vaterite), magnesite (MgCO₃), dolomite (Mg_{0.5}Ca_{0.5}CO₃), strontianite (SrCO₃), and/or witherite (BaCO₃) in the shells and to protect the encapsulated bitumen from water damage. In certain embodiments, precipitated carbonates imbue surface roughness, which prevents microcapsule agglomeration, and can additionally form water-resistant complexes with acidic moieties in bitumen, which, in turn, slows down the aging process.

In certain embodiments, the subject bitumen microcapsules can be prepared through a two-step process. In the first step, a single-nozzle system can be used to prepare microdroplets of bitumen. In the next step, the microdroplets of uncoated bitumen are conformally coated by immersion in an aqueous solution of a cationic polyelectrolyte, followed by powder bed coating in a mixture of a lignosulfonate polyanionic electrolyte and, optionally a material such as hydrated lime or the like (e.g., Ca(OH)₂ (hydrated lime), calcium oxide, magnesium hydroxide, magnesium oxide, barium hydroxide, barium oxide, strontium hydroxide, strontium oxide, baralyme (BaCaH₅KO₅), soda lime, oxides of silicon, aluminum, iron and calcium (such as pozzolans and fly ash), and siliceous and/or siliceous and aluminous materials from pure materials and/or naturally-sourced materials (including volcanic ash, pumice, opaline shales, burnt clay).

The subject invention provides a strategy to mitigate the challenges of transporting bitumen through the encapsulation of modified bitumen within polyelectrolyte microcapsules. In certain embodiments, the microdroplets of modified bitumen can be shaped using a single-nozzle system. In certain embodiments, the microcapsules show exceptional thermal and mechanical stability and tolerance to high-humidity conditions. In certain embodiments, the microcapsules have a diameter of about 4 mm and show a stress-withstanding ability as high as 131±13.5 kN/m² and can withstand impact velocities ranging up to 35 m/s. Therefore, the microcapsules entirely satisfy requirements for bitumen transportation infrastructure including free-fall and extended storage in shipping containers. The subject bitumen microcapsules can be fluidized directly at the point of application with only a modest increase in viscosity resulting from the shell materials.

### BRIEF DESCRIPTION OF THE DRAWINGS

The patent or application file contains at least one drawing executed in color. Copies of this patent or patent application publication, with color drawing(s), will be provided by the Office upon request and payment of the necessary fec.

FIGS. 1A-1C. Schematic illustration of a stepwise process for the preparation of rubber- and polymer-modified bitumen microcapsules. FIG. 1A: AB6 (at 180° C.), PMB Conc. (at 200° C.) or S45R (at 200° C.) is injected through a 3 mm diameter flow nozzle attached to a high-pressure syringe pump. The microdroplets are collected in hemispherical molds on an aluminum slab that has been chilled to a temperature of about −78° C. using a dry ice bath. FIG. 1B: Two-step coating process wherein microdroplets from FIG. 1A are immersed in a polycationic PDAC aqueous solution, followed by powder-bed mixing with polyanionic sodium lignosulfonate and Ca(OH)₂ in a 3:2 (w/w) ratio. FIG. 1C; Digital photograph of microcapsules after drying for 12 h.

FIGS. 2A-2B. Water uptake in Microcapsules as a Proportion of Ca(OH)₂ Incorporation. Digital photographs of microcapsules incorporating different weight percentages of Ca(OH)₂ in the shell on FIG. 2A day 0 and FIG. 2B day 7.

FIGS. 3A-3D. Effect of Curing Temperature on Microcapsule Structural Integrity. Digital photographs of AB6 microdroplets coated with a PDAC initial layer and sodium lignosulfonate and Ca(OH)₂ 3:2 (w/w) outer layer at 23° C. The microcapsules are maintained at temperatures of 23, 40, and 50° C. Digital photographs are acquired on day 0 (FIG. 3A) and day 7 (FIG. 3B). Digital photographs of microcapsules of AB6, PMB Conc, and S45R prepared at 50° C. (FIG. 3C) immediately after preparation and storage at 50° C. for 7 days (FIG. 3D).

FIGS. 4A-4C. Electron Microscopy and Vibrational Spectroscopy Characterization of Microcapsules. (FIG. 4A) SEM image and (FIG. 4B) confocal fluorescence images of AB6 microdroplets coated with a PDAC initial layer and sodium lignosulfonate and Ca(OH)₂ 3:2 (w/w) outer layer at 50° C. FIG. 4A Panels i-iv show a panoramic view of the surface, whereas FIG. 4A Panels v-vi show cross-sectional images. (FIG. 4C) FTIR spectrum of shell material, sodium lignosulfonate, PDAC, and Ca(OH)₂.

FIGS. 5A-5B. Cross-sectional Images and Mechanical Properties of Microcapsules. FIG. 5A: Cross-sectional fluorescence images of a sectioned microcapsule of (Panel i) AB6 (3.55 mm diameter capsule with a shell thickness of 0.20±0.06 mm), (Panel ii) PMB Conc. (4.04 mm capsule with a shell thickness of 0.19±0.06 mm), and (Panel iii) S45R (3.49 mm capsule with a shell thickness of 0.22±0.08 mm); the region with the higher fluorescence intensity corresponds to the shell coating, whereas the non-fluorescent region corresponds to the modified bitumen core. FIG. 5B: Stress-withstanding abilities of 4 mm microcapsules for three types of modified bitumen stored at the temperatures noted in the axis labels. The x-axis denotes microdroplets of different types of binder coated with an initial layer of PDAC and a sodium lignosulfonate and Ca(OH)₂ 3:2 (w/w) outer layer at 50° C.

FIGS. 6A-6C. Results of Impact Velocity Tests: Time sequences from a video of microcapsules impacting an aluminum surface at 21.5 (FIG. 6A) and 19.4 m/s (FIG. 6B). Each grid block in the background corresponds to dimensions of 1 cm×1 cm. The numbers on the left corner of the images in FIGS. 6A-6B indicate the frame number; the high-speed camera captures images at 12,000 frames per second. FIG. 6C: Maximum safe impact velocity for the microcapsules of polymer and rubber-modified bitumen. The x-axis indicate different types of binder microdroplets covered with an initial layer of PDAC and a sodium lignosulfonate and Ca(OH)₂ 3:2 (w/w) outer layer at 50° C. The black labels on the x-axis represent the 7-day storage temperature for the microcapsules.

FIG. 7. Rheological properties of unencapsulated bitumen blends contrasted to microcapsules. This graph shows a comparison of the viscosity profiles for AB6, PMB Conc, and S45R binders along with their modified versions as microdroplets that have been coated with an initial layer and an outer layer of sodium lignosulfonate and Ca(OH)₂ in a 3:2 ratio (w/w) at a temperature of 50° C.

FIGS. 8A-8B. Digital photographs illustrating precipitation of PDAC and SL. 70 v/v % PDAC added to 10 w/v. % SL aqueous solution (FIG. 8A) and 10 w/v. % aqueous solution of SL and Ca(OH)₂ in a 1:1 (w/w) ratio (FIG. 8B).

### DETAILED DISCLOSURE OF THE INVENTION

As used herein, the singular forms “a”, “an” and “the” are intended to include the plural forms as well, unless the context clearly indicates otherwise. To the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, “comprise”, “consisting essentially of”, “consists essentially of”, “consisting” and “consists” can be used interchangeably.

The phrase “consisting essentially of” or “consists essentially of” indicates that the described embodiment encompasses embodiments containing the specified materials or steps and those that do not materially affect the basic and novel characteristic(s) of the described embodiment.

The term “about” means within an acceptable error range for the particular value as determined by one of ordinary skill in the art, which will depend in part on how the value is measured or determined, i.e., the limitations of the measurement system. In the context of the lengths of polynucleotides where the terms “about” are used, these polynucleotides contain the stated number of bases or base-pairs with a variation of 0-10% around the value (X±10%). In the context of compositions containing amounts of ingredients where the terms “about” or “approximately” are used, these compositions contain the stated amount of the ingredient with a variation (error range) of 0-10% around the stated value (X±10%).

In the present disclosure, ranges are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc. Values having at least two significant digits within a range are envisioned, for example, a range of 5-10 indicates all the values between 5.0 and 10.0 as well as between 5.00 and 10.00 including the terminal values. When ranges are used herein, such as for the size of the peptides, the combinations and sub-combinations of the ranges (e.g., subranges within the disclosed range) and specific embodiments therein, are explicitly included.

As used herein, the term “reduce” or “decrease” (and grammatical variants thereof) refers to a negative alteration of at least 1%, 5%, 10%, 25%, 50%, 75%, or 100% with respect, to, for example, the viscosity of a substance.

As used herein, the term “enhance” or “increase” (and grammatical variants thereof) refers to a positive alteration of at least 1%, 5%, 10%, 25%, 50%, 75%, or 100% with respect to, for example, the impact resistance of microencapsulated bitumen.

As used herein, “bitumen” refers to asphalt. As used herein, “rubber-modified bitumen” refers to bitumen with incorporated rubber. As used herein, “polymer-modified bitumen” refers to bitumen that is combined with one or more polymer materials.

The term “and/or” as used herein refers to and encompasses any and all possible combinations of one or more of the associated listed items. For example, the phrase “A, B, and/or C” includes A alone, B alone, C alone, the combination of A and B, the combination of A and C, the combination of B and C, and the combination of A, B, and C. Also, the term “or” is used in its inclusive sense (and not in its exclusive sense) so that when used, for example, to connect a list of items, the term “or” means one, some, or all of the items in the list. Conjunctive language such as the phrase “at least one of X, Y, and Z,” unless specifically stated otherwise, is otherwise understood with the context as used in general to convey that an item, term, etc. may be either X, Y, or Z; X and Y; X and Z; Y and Z; or X, Y, and Z (i.e., any combination of X, Y, and Z).

### Microencapsulated Compositions

The subject invention pertains to an encapsulated bitumen or a derivative thereof, such as, for example, rubber-modified bitumen (RMB) or polymer-modified bitumen (PMB). In certain embodiments, the rubber of the RMB is, for example non-vulcanized or vulcanized crumb rubber, natural rubber, desulphurized rubber, nitrile rubber, styrene butadiene rubber, butyl rubber, acryl rubber, fluoride rubber (as defined by ASTM International standard D1418), neoprene, fluorosilicone rubber, and/or polyisoprene and can be present in a concentration of about 1% to about 50%, about 5% to about 30%, or about 15% in the RMB. In certain embodiments, crumb rubber, which can be derived from waste tires, comprises an elastomer, such as, for example a natural or synthetic rubber with additives, including, for example styrene-butadiene copolymer, silica, or carbon black, and, optionally, a cord, such as, for example, a steel, cotton, silk, nylon, or Poly-paraphenylene terephthalamide cord. In certain embodiments, the RMB further comprises an elastomeric binder with PG64S base bitumen at a concentration of about 10 wt. %. In certain embodiments, the PMB comprises PG64S base bitumen at a concentration of about 10-20%, preferably about 15% wt. %. In certain embodiments, PMB contains a polymer, such as, for example, styrene-butadiene-styrene (SBS) polymer, at a concentration of about 1% to about 50%, about 5% to about 25%, about 6% to about 12%, or about 7% to about 12%. S45R, is an elastomeric binder with PG64S base bitumen, incorporates about 15 wt. % waste tire-derived crumb rubber. AB6 contains about 6-7 wt. % polymer and about 93-94% base bitumen. PMB contains about 12% polymer and about 88% base bitumen. In certain embodiments, the bitumen can be encapsulated in a polyanionic electrolyte, such as for example, alkali lignin, alkaline lignin, and/or lignosulfate or salts thereof (such as sodium, calcium, magnesium, and/or ammonium salts), and a cationic polyelectrolyte shell, such as, for example, poly(diallyl dimethylammonium chloride) (PDAC), polyethyleneimine (PEI), diethylaminoethyl-dextran (DEAE-dextran), poly(amidoamine) (PAMAM) dendrimers; polyamidoamine, mannosylated PEI, and/or any block copolymer containing cationic fragments such as poly(ethylene oxide)-block-poly(vinyl benzyl trimethylammonium chloride) or poly(2-methacryloyloxyethyl phosphorylcholine methacrylate)-block-poly(vinyl benzyl trimethylammonium chloride).

In preferred embodiments, the lignosulfonate is sodium lignosulfonate. In order to encapsulate bitumen, a polyanionic electrolyte is alternated with a cationic polyelectrolyte, such as, for example, PDAC, through a layer-by-layer assembly process. In certain embodiments, a material such as Ca(OH)₂ (hydrated lime) and/or other materials, such as calcium oxide, magnesium hydroxide, magnesium oxide, barium hydroxide, barium oxide, strontium hydroxide, strontium oxide, baralyme (BaCaH₅KO₅), soda lime, as well as oxides of silicon, aluminum, iron and calcium (such as pozzolans and fly ash), and siliceous and/or siliceous and aluminous materials from pure materials and/or naturally-sourced materials (for example, volcanic ash, pumice, opaline shales, burnt clay) can be incorporated as a precursor to the layering process, during the layering process, and/or after the layering process. In certain embodiments, at least 1, 2, 3, 4, 5, 6, 7, 8, 9, 10 or more layers of the cationic polyelectrolyte can encapsulate the bitumen. In certain embodiments, at least 1, 2, 3, 4, 5, 6, 7, 8, 9, 10 or more layers of the polyanionic electrolyte can encapsulate the bitumen. In some embodiments, a material such as Ca(OH)₂ (hydrated lime) and/or other materials, such as calcium oxide, magnesium hydroxide, magnesium oxide, barium hydroxide, barium oxide, strontium hydroxide, strontium oxide, baralyme (BaCaH₅KO₅), soda lime, as well as oxides of silicon, aluminum, iron and calcium (such as pozzolans and fly ash), and siliceous and/or siliceous and aluminous materials from pure materials and/or naturally-sourced materials (for example, volcanic ash, pumice, opaline shales, burnt clay) can be mixed with a polyanionic electrolyte for use in the disclosed methods.

In certain embodiments, a polyanionic electrolyte (such as for example, alkali lignin, alkaline lignin, and/or lignosulfate or salts thereof (such as sodium, calcium, magnesium, and/or ammonium salts) and Ca(OH)₂ can be layered on the bitumen simultaneously. Alternatively, a mixture of the polyanionic electrolyte and Ca(OH)₂ can be provided in various ratios, such as about 3:2 (w/w) or X:Y, where X and Y are each, independently, 1, 2, 3, 4, 5, 6, 7, 8, 9, 10, 11, 12, 13, 14, 15, 16, 17, 18, 19, or 20. In other embodiments, a mixture of polyanionic electrolyte and another material (e.g., Ca(OH)₂, calcium oxide, magnesium hydroxide, magnesium oxide, barium hydroxide, barium oxide, strontium hydroxide, strontium oxide, baralyme (BaCaH₅KO₅), soda lime, as well as oxides of silicon, aluminum, iron and calcium (such as pozzolans and fly ash), and siliceous and/or siliceous and aluminous materials from pure materials and/or naturally-sourced materials (for example, volcanic ash, pumice, opaline shales, burnt clay)) can have a ratio anywhere from 1:20 to 20:1 (e.g., X:Y, where X and Y are each, independently, 1, 2, 3, 4, 5, 6, 7, 8, 9, 10, 11, 12, 13, 14, 15, 16, 17, 18, 19, or 20).

In certain embodiments, lignosulfonates and/or salts thereof (i.e., lignin-based anionic polyelectrolytes) can be derived from waste biomass from the sulfite wood pulping process. In certain embodiments, the lignosulfonates are high-molecular-weight lignosulfonates (e.g., 103-106 g/mol) that have backbones comprising confieryl, p-coumaryl, and sinapyl aromatic alcohols connected by ether and C—C bonds. Owing to the abundance of sulfonate and carboxylic groups, lignosulfonates exhibit hydrophilic characteristics and can be cross-linked such as through the formation of amide, ester, anhydride, and sulfonate ester linkages.

### Method of Preparing the Microencapsulated Composition

In certain embodiments, in order to prepare the encapsulated bitumen, the bitumen or a derivative thereof can be fed into a stainless-steel syringe with a nozzle with a diameter of about 1 mm to about 10 mm or about 3 mm and both the nozzle and bitumen or derivative thereof can be heated to temperatures of about 50° C. to about 220° C., about 50° C. to about 100° C., about 50° C. to about 75° C., about 150° C. to about 220° C., about 180° C. to about 220° C., about 50° C. to about 200° C., about 50° C. to about 100° C., about 50° C. to about 75° C., about 150° C. to about 200° C. or about 180° C. to about 200° C. . . . In certain embodiments, a tray, such as, for example, an aluminum tray can be placed directly below the opening of the nozzle at a distance of about 0.01 m to about 15 m, about 0.5 m to about 15 m, about 1 m to about 15 m or about 5 m to about 10 m, or about 1 m to about 10 m. In certain embodiments, the tray can contain molds to shape the ejected bitumen into, for example, quasi-spherical microdroplets. In certain embodiments, the molds are hollow hemispherical molds with a diameter of about 10 μm to about 100 mm, about 1 mm to about 10 mm or about 5 mm. In certain embodiments, the mold tray can be cooled in a dry ice bath for about 1 h or in a liquid nitrogen bath for about 5 min. In certain embodiments, the bitumen can be extruded in the form of microdroplets through the nozzle at a flow rate between about 0.05 to about 10 mL/min or about 0.5 and about 1 mL/min. In certain embodiments, the collected microdroplets can be stored in a 2 wt. % aqueous solution of poloxamer 407 or other suitable liquid or used directly as the core material for deposition of the polyelectrolyte shell.

In certain embodiments, the microdroplets of bitumen can be dried for about 2 to about 3 mins under an air pressure of about 10 psi. In certain embodiments, the microdroplets of bitumen can be mixed with a liquid solution containing a cationic polyelectrolyte, such as, for example, a PDAC aqueous solution diluted to 70% (v/v) with deionized water (conductivity <18 mΩ/cm at 25° C.). Other non-limiting examples of cationic polyelectrolytes include Polyethyleneimine (PEI), Diethylaminoethyl-dextran (DEAE-dextran), Poly(amidoamine) (PAMAM) dendrimers, polyamidoamine, mannosylated PEI, any block copolymer containing cationic fragments such as Poly(ethylene oxide)-block-poly(vinyl benzyl trimethylammonium chloride) or poly(2-methacryloyloxyethyl phosphorylcholine methacrylate)-block-poly(vinyl benzyl trimethylammonium chloride). In certain embodiments, the microdroplets of bitumen can be mixed in the cationic polyelectrolyte solution for about 1 min to about 10 min or about 1 min to about 2 min to enable surface adsorption of the cationic polyelectrolyte. In certain embodiments, the microdroplets of bitumen can be recovered by straining through a standard stainless-steel sieve with a mesh size of 20 (i.e., a pore size of about 850 μm) and transferred to a mixture of a polyanionic electrolyte (such as an alkali lignin, alkaline lignin, and/or lignosulfate or salts thereof, for example a sodium, calcium, magnesium, and/or ammonium salt and another material such as Ca(OH)₂ (i.e., hydrated lime) and/or other materials, such as calcium oxide, magnesium hydroxide, magnesium oxide, barium hydroxide, barium oxide, strontium hydroxide, strontium oxide, baralyme (BaCaH₅KO₅), soda lime, as well as oxides of silicon, aluminum, iron and calcium (such as pozzolans and fly ash), and siliceous and/or siliceous and aluminous materials from pure materials and/or naturally-sourced materials (for example, volcanic ash, pumice, opaline shales, burnt clay), preferably Ca(OH)₂. In some embodiments, the polyanionic electrolyte is sodium lignosulfonate, and the ratio of the polyanionic electrolyte to Ca(OH)₂ is about 3:2 (w/w). In various embodiments, the polyanionic electrolyte and the Ca(OH)₂ are in powder form. In yet other embodiments, the ratio of polyanionic electrolyte (X) to another material (Y) can be X:Y, where X and Y are each, independently, 1, 2, 3, 4, 5, 6, 7, 8, 9, 10, 11, 12, 13, 14, 15, 16, 17, 18, 19, or 20 and Y is, for example, Ca(OH)₂ (i.e., hydrated lime) and/or other materials, such as calcium oxide, magnesium hydroxide, magnesium oxide, barium hydroxide, barium oxide, strontium hydroxide, strontium oxide, baralyme (BaCaH₅KO₅), soda lime, as well as oxides of silicon, aluminum, iron and calcium (such as pozzolans and fly ash), and siliceous and/or siliceous and aluminous materials from pure materials and/or naturally-sourced materials (for example, volcanic ash, pumice, opaline shales, burnt clay) or mixtures thereof. In certain embodiments, the mixing of the bitumen microdroplets with the cationic polyelectrolyte, polyanionic electrolyte, and Ca(OH)₂ can be performed at about 18° C. to about 80° C. or about 25° C. to about 75° C. or about 50° C. The polyanionic electrolyte and other material, for example, Ca(OH)₂ (i.e., hydrated lime) and/or other materials, such as calcium oxide, magnesium hydroxide, magnesium oxide, barium hydroxide, barium oxide, strontium hydroxide, strontium oxide, baralyme (BaCaH₅KO₅), soda lime, as well as oxides of silicon, aluminum, iron and calcium (such as pozzolans and fly ash), and siliceous and/or siliceous and aluminous materials from pure materials and/or naturally-sourced materials (for example, volcanic ash, pumice, opaline shales, burnt clay) or mixtures thereof may be in the form of a powder.

In certain embodiments, the resulting microcapsules can be vigorously agitated for about 2 to about 5 min. In certain embodiments, the resulting microcapsules can be dried for about 12 h at about 23° C. with continuous shaking in an incubator shaker at about 300 RPM. In certain embodiments, the encapsulated bitumen can be separated from the any excess polyanionic electrolyte and the Ca(OH)₂ using a size 20 stainless steel mesh sieve.

In certain embodiments, the microcapsules containing bitumen are stable up to temperatures of at least about 25° C., about 30° C., about 35° C., about 40° C., about 45° C., or about 80° C., can tolerate stresses of at least about 50 kN/m², about 75 kN/m², about 100 kN/m², about 117.5 kN/m², about 131 kN/m², about 144.5 kN/m², or about 150 kN/m², for microcapsules having a diameter of about 10 μm to about 100 mm, about 1 mm to about 5 mm, or about 4 mm and have safe impact velocities of at least about 5 m/s, about 10 m/s, about 15 m/s, about 19 m/s, about 25 m/s, about 30 m/s, about 35 m/s, or about 40 m/s. As such, the microcapsules entirely satisfy requirements for current handling and transportation infrastructure including free-fall and storage in large containers. Crushed microcapsules can be directly used by fluidization at the point of application with only a modest increase in viscosity resulting from the shell materials.

### Materials and Methods

### Rubber-Modified and Polymer-Modified Bitumen

Rubber-modified bitumen (RMB), such as, for example, S45R, and polymer-modified bitumen (PMB), such as, for example, AB6 and PMB Conc., were supplied by Puma Energy (Australia) Bitumen Pvt Ltd. S45R, an elastomeric binder with PG64S base bitumen, incorporates about 15 wt. % waste-tire-derived crumb rubber while AB6 and PMB Conc. contain PG64S base bitumen with 6-7 wt. % and 12 wt. % styrene-butadiene-styrene (SBS) polymer, respectively. Sodium lignosulfonate, Ca(OH)₂, a triblock copolymer of polyethylene glycol and polypropylene glycol (Pluronic F-127), and PDAC (35 wt. % aqueous solution) were procured from Millipore Sigma and used as received. Fusion series high-pressure syringe pump and stainless-steel syringes with volumetric capacities of 100 and 200 mL from Chemyx (Stafford, Texas, USA) and heating tape from Ace Glass (Vineland, New Jersey, USA) were used to heat the bitumen to 180-200° C. and pump the rubber/polymer-modified bitumen through the nozzle.

A custom-designed nozzle with a diameter of 3 mm, a low-alloy steel pipe (18 cm in length, 0.4 cm in diameter) to connect the nozzle to the syringe, and an aluminum slab with an array of 200 hollow hemispherical molds each of 5 mm diameter were custom fabricated at the machine shop at Texas A&M University (College Station, Texas, USA).

Compression tests were performed with an FG-3000 series digital force gauge purchased from Cole-Parmer (Vernon Hills, IL). Impact test studies were monitored using a Fastcam (Chicago, Illinois, USA) NOVA S9 camera mounted with an EF-S 18-135 mm lens. A collimated LED light source from Thorlabs was used to illuminate the path traversed by microcapsules. A F-16 slingshot purchased from Daisy was used to launch the microcapsules into a 0.6″ thick 6061 aluminum bar from McMaster-Carr (Elmhurst, Illinois, USA) and a 0.2″ thick corrugated cardboard substrate.

### Preparation of RMB or PMB Microdroplets

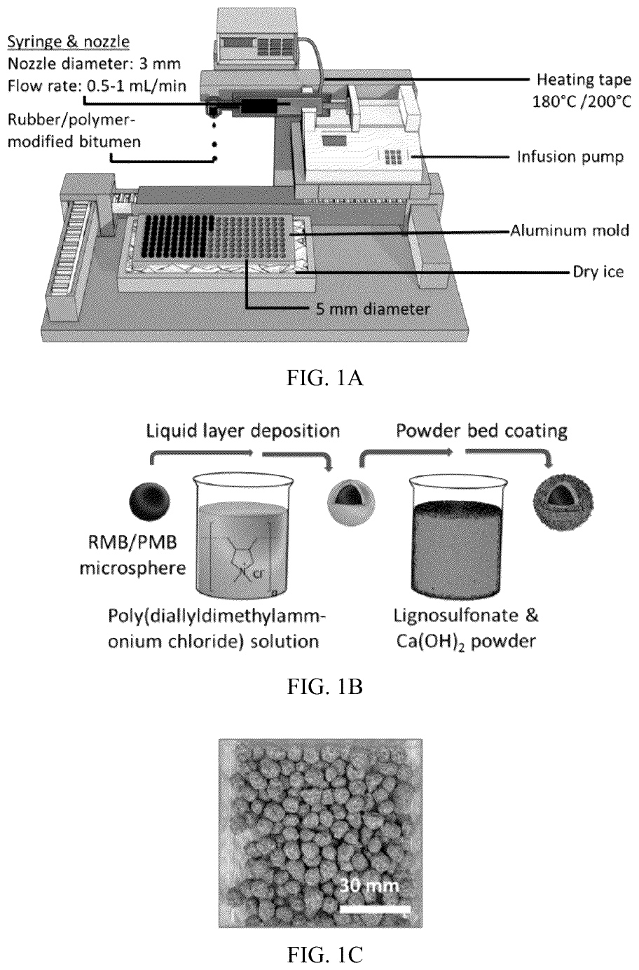

PMB or RMB was loaded within a 100 mL stainless-steel syringe. An 18 cm low alloy steel pipe connected the stainless-steel syringe to a 3 mm diameter nozzle. The nozzle was mounted 50 cm above the benchtop as sketched in FIG. 1A. The syringe, low alloy steel pipe, and nozzle were heated to temperatures of 180 or 200° C. with the aid of a heating tape (180° C. for AB6 and 200° C. for PMB Conc. and S45R). The bitumen and the flow setup were maintained at the set temperature for about 1 h. An aluminum tray with dimensions of 12.7 cm×6.40 cm×0.76 cm was placed directly below the opening of the nozzle at a distance of about 5 cm. Each aluminum tray contained 200 hollow hemispherical molds (each 5 mm in diameter) to shape the ejected bitumen into quasi-spherical microdroplets. The mold tray was cooled in a dry ice bath for 1 h or in a liquid nitrogen bath for 5 min. Viscoelastic bitumen heated to the appropriate temperatures noted above was extruded in the form of microdroplets through the nozzle at a flow rate between 0.5-1 mL/min. The droplets were collected in the cooled hollow hemispherical divots on the aluminum mold. The flow rates were adjusted by controlling the pressure of the syringe pump. The speed of the mold tray was also modified by decreasing or increasing its movement relative to the flow rate. After complete filling of the molds, the frozen bitumen microdroplets were removed into a glass pneumatic trough by simply tapping the back of the mold tray. The collected microdroplets were stored in a 2 wt. % aqueous solution of Pluronic F127 or used directly as the core material for deposition of the polyelectrolyte shell.

### Encapsulation Process

A total of 100 RMB or PMB Microdroplets were directly transferred or drained from the surfactant bath into a 200 mL glass beaker. The microdroplets were then dried for 2-3 min under an air pressure of about 10 psi by covering the mouth of the container with a thick perforated aluminum sheet. The materials were then transferred to another 200 mL glass beaker containing a 20 mL PDAC aqueous solution diluted to 70% (v/v) with deionized water (conductivity <18 mΩ/cm at 25° C.). Next, the microdroplets were stirred in the cationic polyelectrolyte solution for 1-2 min to enable surface adsorption of the polyelectrolyte. Next, the incipient microcapsules were recovered by straining through a standard stainless-steel sieve with a mesh size of 20 and transferred to another 200 mL glass beaker containing a 50 g powder bed with an mixture of sodium lignosulfonate and Ca(OH)₂ in a 3:2 (w/w) ratio prepared using an electrical blender. The obtained microcapsules were then left to dry for 12 h at 23° C. with continuous shaking in an incubator shaker at 300 RPM. In order to prevent agglomeration, the powder bed mixture was vigorously agitated for 2-5 min before placing the beaker onto the incubator. The coated core-shell particles were separated from the powder mixture using a size 20 stainless steel mesh sieve and collected for characterization and storage. The stepwise process is illustrated in FIG. 1B; FIG. 1C shows a digital photograph of the prepared microcapsules.

### SEM

Surface and cross-sectional SEM images of the coated RMB/PMB microcapsules were obtained using a JEOL JSM-7500F ultra-high-resolution field-emission instrument. Microcapsules were affixed onto aluminum stubs using carbon tape. Prior to loading in the SEM, the samples were coated with Pt (5 nm) using a Cressington (Watford, Hertfordshire, England) 208HR sputter coater to prevent charge accumulation.

### Scanning Fluorescence Imaging

In addition to optical microscopy, fluorescence illumination was used to differentiate core and shell components of the microcapsules. The images were captured using a Leica (Wetzlar, Germany) DM 6B upright microscope equipped with a Leica DFC7000T camera and LAS X (St. Paul, Minnesota, USA) navigator software. Imaging was performed using a 2.5× objective lens. The halide lamp excitation wavelength was set to 620 nm; excitation/emission filters were set to 590-650 nm and 662-738 nm, respectively. The acquired were processed with ImageJ software.⁴⁷

### FTIR Spectroscopy

The shell material was characterized by FTIR spectroscopy. Data were collected on a Bruker (Billerica, Massachusetts, USA) Vertex-70 instrument using a Pike MIRacle (Madison, Wisconsin, USA) single-reflection horizontal attenuated total reflectance (ATR) accessory. The spectra were collected at room temperature between 600-000 cm⁻¹ with 32 scans acquired at a resolution of about 1 cm-4 cm.

### Velocity Impact Tests

To evaluate the viability of the prepared microcapsules upon impact, the prepared microcapsules were propelled against a 1.5 cm thick aluminum surface using a slingshot setup.⁴⁸ In brief, the impact was recorded using a Fastcam NOVA S9 high-speed recording camera set up normal to the direction of the projectile. A collimated LED light source illuminated the path of the projectile. A calibrated ruler held parallel to the projectile motion recorded the distance traveled by the projectile per frame. The frames were combined in the FASTCAM photo viewer software to produce a video displaying the motion of the microcapsule as it collides with the target surface.

### Stress-Withstanding Ability

Prepared microcapsules that are about 4 mm in diameter were evaluated for their load-bearing capacities using a previously described apparatus.⁴⁹ Briefly, an FG-3000 series digital force transducer mounted on a vibration-free table was affixed normal to the center of the microcapsule. As the microcapsule moved towards the transducer at a rate of about 1 mm/s on a moving jack, the transducer sensed the compressive force experienced by the microcapsule. The force at the point of deformation of the microcapsule and the radius of the microcapsule were used to calculate its stress-withstanding stability.

### Thermal Stability Tests

A batch of microcapsules was placed on the surface of a 50 mL glass beaker. The beaker was then placed in a Thermo Scientific (Waltham, Massachusetts, USA) 2000 series muffle furnace for 7 days at a temperature of 50° C. The microcapsules were visually examined for signs of agglomeration and leakage.

### Rheology Measurements

The viscosity of RMB and PMB with and without shell material incorporation was measured using a Discovery Hybrid DHR-2 rheometer (TA Instruments (New Castle, Delaware, USA)) equipped with a parallel plate setup in rotational mode. The system was configured to ramp across a temperature range of 120-200° C. at a ramp rate of 10° C. To ensure consistent measurement for the solid-phase microcapsules, they were compressed, ruptured, and blended at 100° C. until they achieved a smooth, flowing consistency. The viscoelastic material was placed between 40 mm parallel plates separated by a 2000 μm gap. The viscosities were recorded at a constant shear rate of 1.0 s⁻¹. In another set of experiments, 8 mm parallel plates separated by a 1000 μm gap were used to measure the viscosity of the modified bitumen mixtures at 23° C. and 50° C. A Peltier cooler was used to maintain a constant temperature. Rheology data were processed using the TA instruments software TRIOS and plotted in Origin.

All patents, patent applications, provisional applications, and publications referred to or cited herein are incorporated by reference in their entirety, including all figures and tables, to the extent they are not inconsistent with the explicit teachings of this specification.

Following are examples which illustrate procedures for practicing the invention. These examples should not be construed as limiting. All percentages are by weight and all solvent mixture proportions are by volume unless otherwise noted.

### Example 1—Rheological Behavior of Bitumen Blends and Encapsulation Process

Three different types of RMB and PMB mixtures have been used. S45R, an elastomeric binder with PG64S base bitumen, incorporates about 15 wt. % waste-tire-derived crumb rubber. The viscosity of S45R is 1281 Pa·s at 23° C. and 86 Pa·s at 50° C. AB6 and PMB Conc. are elastomeric binders with PG64S base bitumen containing 6-7 wt. % and 12 wt. % SBS polymers, respectively. At 23° C., measured viscosity values of AB6 and PMB conc. are 1153 and 1600 Pa·s, respectively; at a temperature of 50° C., the viscosities are reduced to 113 and 491 Pa·s, respectively. Intriguingly, S45R, which has a higher viscosity as compared to AB6 at 23° C., shows a lower viscosity at 50° C. The sharp decrease in viscosity of S45R at elevated temperatures is a result of decreased compatibility between the crumb-rubber inclusion and bitumen. The granular dimensions of the crumb rubber fillers are larger than polymer granules, which results in a greater diminution of surface energy and increased proclivity for phase separation at elevated temperatures.⁵⁰ Distinctive differences are further expected in the nature of the interphases in these blended composites.⁵¹

The first step in the encapsulation process is the conversion of the RMB or PMB into quasi-spherical microdroplets, which are subsequently coated in the next step. Microdroplets are extruded through a custom-designed single-nozzle system using a stainless-steel syringe attached to a high-pressure syringe pump. The viscoelastic bitumen mixture is fed through the syringe to the nozzle; microdroplets extruded by the nozzle are collected within an aluminum mold (FIGS. 1A-1C). In order to flow the blended bitumen mixtures through the nozzle system, based on their relative viscosities, the AB6 binder is heated at 180° C., whereas PMC Conc. and S45R are heated to 200° C. The extruded microdroplets adopt the quasi-spherical shapes of the chilled aluminum mold. Solidified microdroplets are recovered by tapping the mold against a surface and are either directly coated or stored in an aqueous solution of Pluronic F-127 to prevent agglomeration.

To constitute a shell encasing the microdroplets, the PMB and RMB microdroplets are first dip-coated in an aqueous solution of polycationic PDAC and then shaken in a powder bed of polyanionic sodium lignosulfonate and Ca(OH)₂ (FIGS. 1A-1C). PDAC is adsorbed onto the surfaces of the microdroplets through electrostatic interactions; polyanionic sodium lignosulfonate and Ca(OH)₂ powders are further coated onto the surfaces taking care to prevent agglomeration of incipient PDAC-coated microcapsules by maintaining a relatively low density of added microcapsules in the powder bed. After agitating the microcapsules in the powder bed for 12 h, the dry microcapsules are retrieved using a size 20 mesh sieve size constructed from stainless steel. The average diameter of the obtained microcapsules are 3.95±0.40 mm, 3.91±0.31 mm, and 4.01±0.36 mm for AB6, PMB Conc., and S45R modified bitumen mixtures, respectively. We have systematically examined variations to the encapsulation process such as increasing the curing temperature to 50° C., and the incorporation of varying proportions of hydrated lime in the shell.

The various polar functional groups in sodium lignosulfonate, sulfonic acid, carboxylic acid, phenol, and aliphatic alcohol moieties, engender a substantial proclivity for moisture absorption. These functional groups underpin adsorption of sodium lignosulfonate powders onto PDAC-coated microdroplets that have a substantial amount of surface-adsorbed water. However, moisture absorption by excess sodium lignosulfonate can deleteriously impact bitumen properties. As such, 0-40 wt. % of Ca(OH)₂ has been incorporated in the powder bed along with sodium lignosulfonate in asphalt binder mixtures to alleviate water damage.⁵² This causes an increase in the size of the precipitate formed by PDAC and SL self-assembly, as shown in FIGS. 8A-8B.

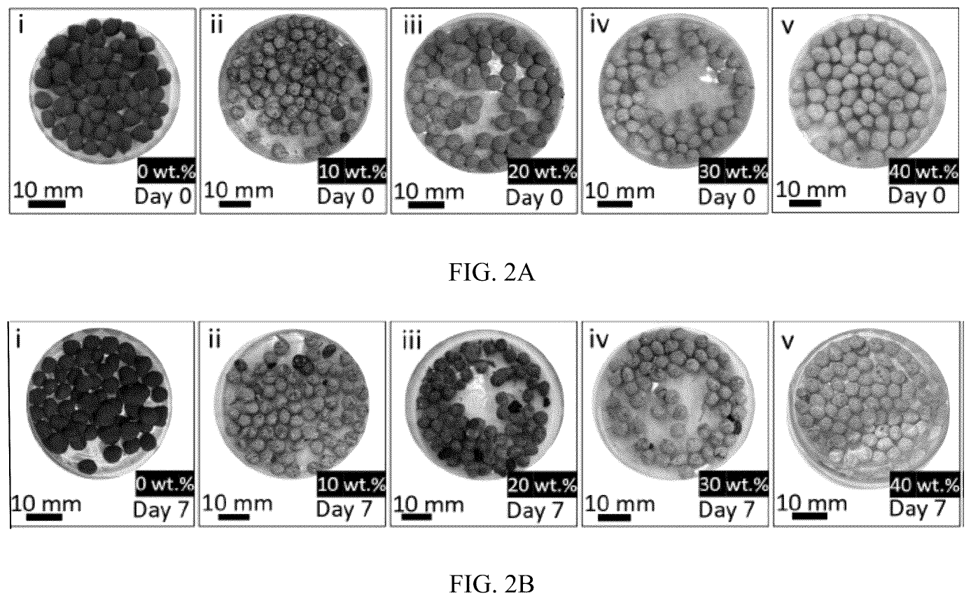

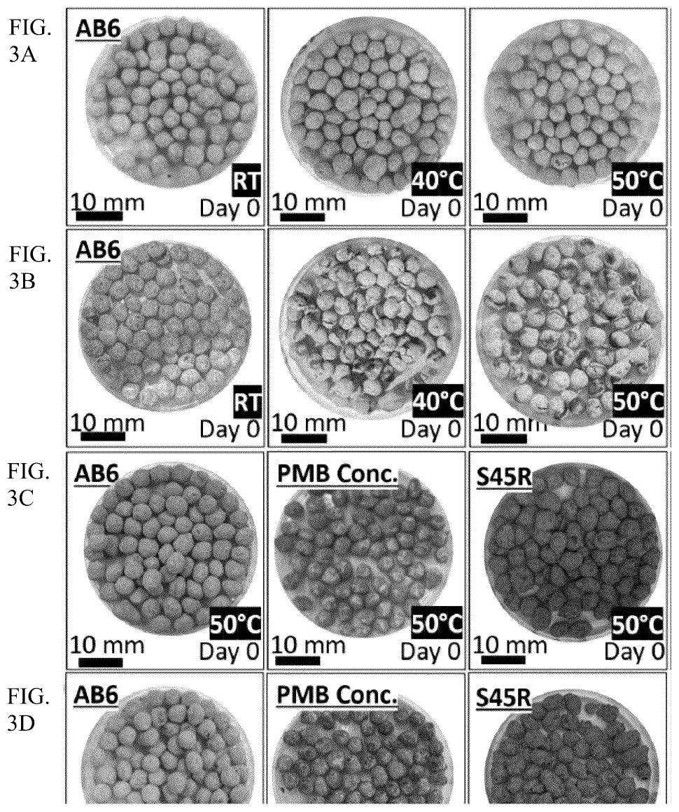

Microcapsules prepared using a powder bed of Ca(OH)₂ and sodium lignosulfonate have been exposed to ambient air with a relative humidity ranging from 55-95% for 7 days. By day 7, microcapsules prepared with 0-20 wt. % Ca(OH)₂ absorbed water, which results in a darker appearance, as shown in FIG. 2B (Panels i-iii). Moreover, the microcapsules are observed to agglomerate and adhere to the container surfaces. In contrast, microcapsules incorporating 30 wt. % Ca(OH)₂ show minimal degradation from water uptake after 7 days, as can be observed in digital photographs in FIG. 2B (Panel iv). Microcapsules incorporating 40 wt. % Ca(OH)₂ are the least permeable to moisture and entirely maintain their structural integrity. As such, shells containing 40 wt. % Ca(OH)₂ are considered for further analysis and optimization.

To further examine the effect of the curing temperature, AB6 microdroplets encapsulated with a PDAC initial layer and sodium lignosulfonate and Ca(OH)₂ 3:2 (w/w) outer layer at 23° C. have been heated to temperatures of 40 and 50° C. Thermal expansion of the bitumen core at higher temperatures strains the rigid shell. Imperfections in the shell result in leakage of bitumen (FIGS. 3A and 3B). As such, with a view towards preventing shell rupture and bitumen release arising from expansion stress at high temperatures, the coating process has been performed at 50° C. onto expanded microdroplet cores by maintaining the PDAC solution, sodium lignosulfonate, and Ca(OH)₂ powder bed, as well as the shaker at 50° C. (FIGS. 3C and 3D). A higher coating temperature further ensures faster solvent evaporation from the shell. FIG. 3D shows that the microcapsules prepared from AB6, PMC Conc., and S45R entirely retain their structural integrity at 50° C. for 7 days with no discernible bitumen leakage.

### Example 2—Shell Characterization

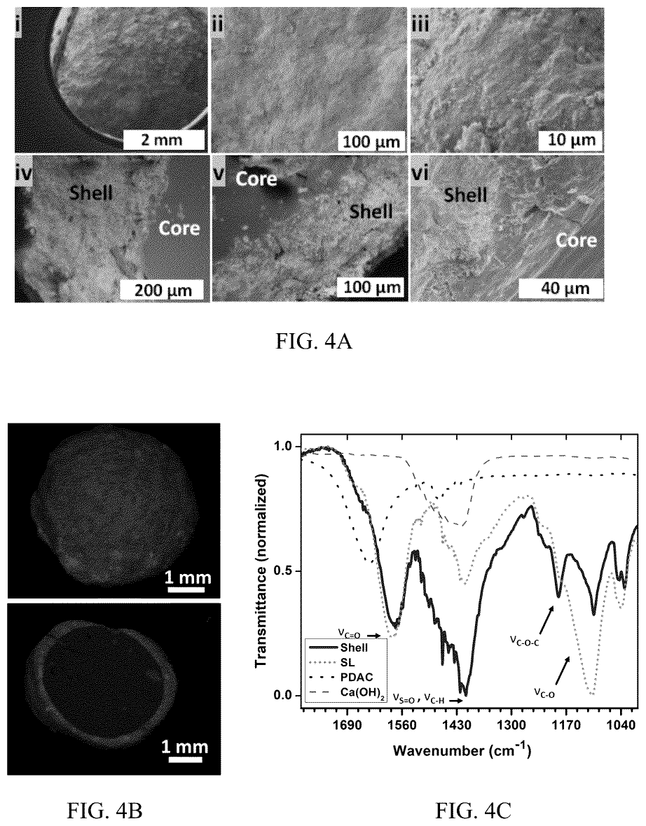

We next turn our attention to characterizing the encapsulating shells. The top panel of FIG. 4A shows SEM images of the microcapsule surfaces prepared at 50° C. The shell comprising sodium lignosulfonate and CaCO₃ particles exhibits a rough surface topography but is observed to be continuous without discernible microscopic porosity. A continuous rough shell with 3D topographical features prevents agglomeration and keeps the microcapsules from adhering to the surfaces of containers. The absence of cracks suggests the need for an optimum balance between the water evaporation rate and the rate of crosslinking. This observation is corroborated by confocal fluorescence imaging results shown in FIG. 4B. To visualize the internal structure of microcapsules, they have been cross-sectioned using a single-edge razor blade dipped in liquid nitrogen for 10 s. The bottom panel of FIG. 4A shows cross-sectional SEM images that clearly differentiate the bitumen core and the polyelectrolyte/carbonate shell. The thickness of the shells varies between 212±97 μm. The SEM images show well-defined interfaces without any apparent discontinuities indicating excellent adhesion of the coatings to microdroplet cores. A clear fluorescence intensity contrast enables differentiation of the microcapsule core and shell, as shown by cross-sectional views exhibited in the bottom panel of FIG. 4B.

The weight percentages of the shell components of the microcapsules have been inferred from weighing the microcapsules before and after the coating process. Three replicates have been performed for each type of bitumen blend for 50 microdroplets. Microdroplets of AB6, PMB Conc., and S45R are deduced to be encapsulated in 22.6±3.2, 22.0±2.1, and 20.3±3.4 wt. % solid shell material.

FTIR-ATR measurements plotted in FIG. 4C further provide insights into the chemical changes in the composition of the shell. FTIR spectra of the shell material show many of the characteristic modes of sodium lignosulfonate and differ significantly from that of PDAC. The shell material exhibits bands characteristic of the functional groups in lignosulfonate. These modes include C—O stretching at 1100 cm-1, C—O—C stretching at 1189 cm-1, and S═O stretching at 1410 cm-1.⁵³

### Example 3—Microcapsule Properties

Transportation of microcapsules in a cylindrical container 6 ft. (182.8 cm) in height and 3 ft. (91.4 cm) as conventionally used in an industrial setting requires microcapsules at the bottom-most layer to withstand stress up to 21.5 kN/m² as per 4FπD2=σ=F_{b}πr2 eq. (1).

Here F, D, σ, F_{b}, and r represent the total force experienced at the bottom of the container (total mass of the microcapsules×acceleration of gravity (g)), the diameter of the container, stress-withstanding ability of an individual microcapsule, force experienced by a single microcapsule in the bottom-most layer, and radius of the microcapsule, respectively. Considering microcapsules with an average diameter of 4 mm weighing about 0.03 g, each container can hold a maximum of 1438 kg of microcapsules. Under these conditions, microcapsules in the bottom-most layer will need to have a stress-withstanding ability of at least 21.5 kN/m².

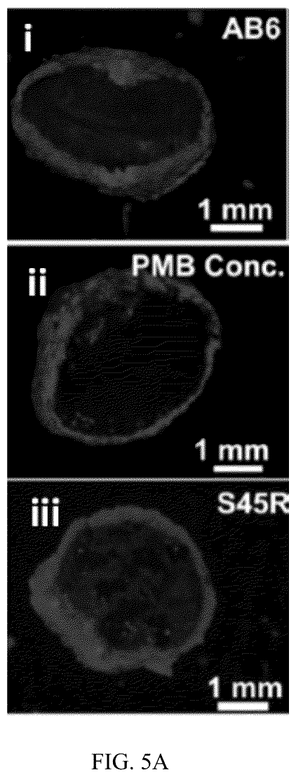

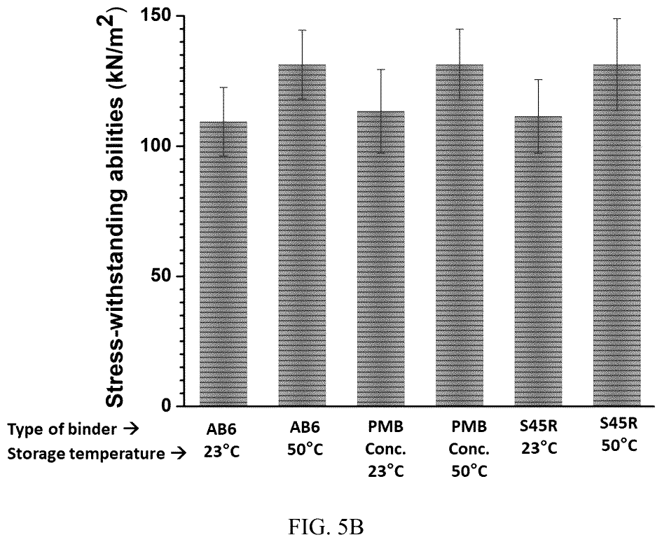

The mechanical strength of the prepared microcapsules has been investigated by subjecting them to different compressive loads. FIG. 5A shows cross-sectional fluorescence microscopy images of microcapsules with similar dimensions as examined in the compressive strength measurements. The images show a clear differentiation between the core and shell and enable evaluation of the shell thicknesses. FIG. 5B compares the stress-withstanding abilities of 4 mm diameter microcapsules encapsulating AB6, PMC Conc., and S45R microdroplets coated with a PDAC initial layer and sodium lignosulfonate and Ca(OH)₂ 3:2 (w/w) outer layer at 50° C. The microcapsules are maintained under an ambient air at 23 and 50° C. for 7 days prior to the mechanical measurements. The strength of the microcapsules maintained at 23° C. varies as AB6<S45R<PMB Conc from 109±13 kN/m² to 111±14 kN/m² to 113±16 kN/m². For similar formulations of the external shell, the variations in stress-withstanding ability reflect the rigidity of the modified bitumen cores. As such, the trend in stress-withstanding ability of the microcapsules is directly correlated with the viscosity values of the modified bitumen cores at 23° C. Intriguingly, as shown in FIG. 5B, the microcapsules stored at 50° C. for 7 days exhibit higher stress-withstanding abilities as compared to those stored at room temperature. The strength of all three microcapsule types remains consistent within 131±17 kN/m2, regardless of variations in their individual core strengths. The results indicate a hardening of the external shell at higher temperatures, likely as a result of greater crosslinking of lignosulfonate functional groups and increased shell density. Notably, even the lower values in FIG. 5B correspond to stress-withstanding values at least four times the minimum value needed for storage in conventional containers. The significant tolerance windows accessible with this method attests to the promise and potential practical viability of PMB/RMB microcapsules described herein for storage and transportation.

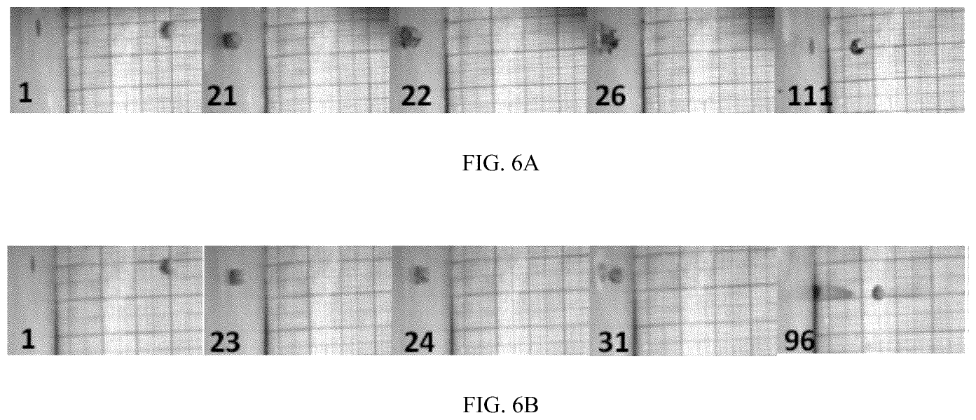

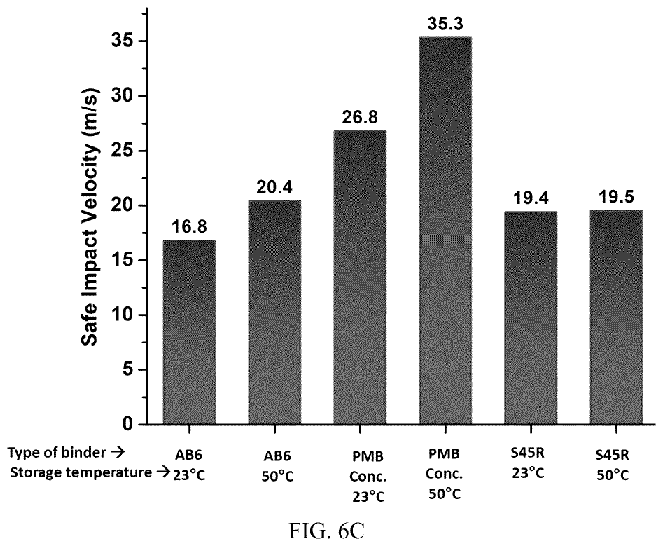

The microcapsules maintained at 23 and 50° C. for 7 days have further been tested for velocity impact to simulate conditions of being poured into a metal base container as shown in FIGS. 6A-6C. High contact stresses can initiate cracks in the microcapsules during transfer to containers or tankers. As such, it is imperative to determine the safe impact velocity under free fall conditions. Impact behavior depends on numerous factors such as projectile shape and size, impact velocity, thickness of the target, modulus of the target, and impact angle. We have contrasted the impact behavior of 2.5 mm diameter microcapsules prepared at 50° C., which have been shot perpendicular into a 0.6″-thick Al substrate. The microcapsules are launched as projectiles using a slingshot, and the velocity upon impact is determined as described in the Methods section.

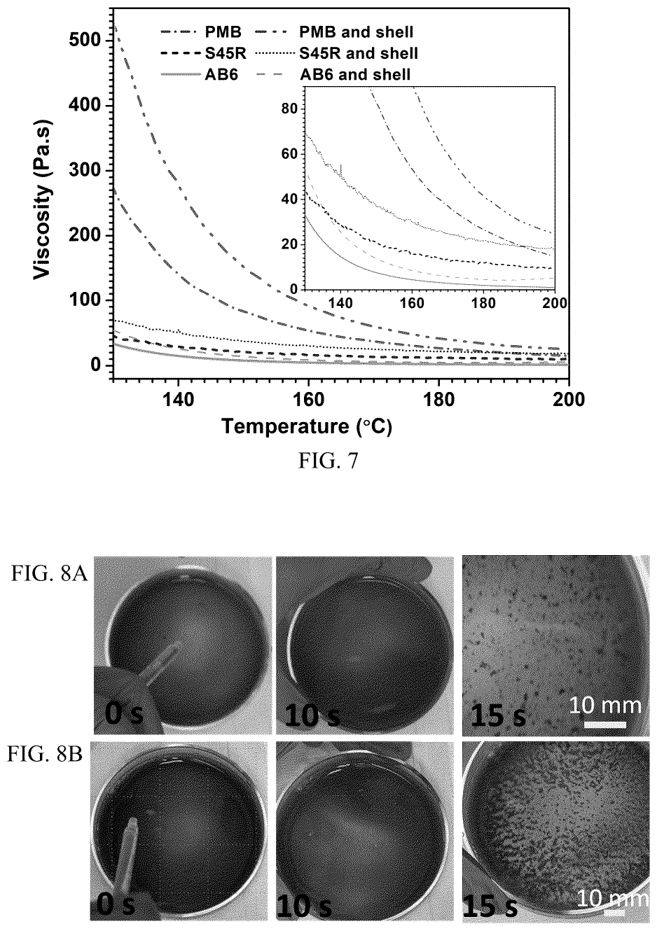

FIGS. 6A and 6B display a time sequence of high-speed camera snapshots demonstrating the impact of microcapsules onto an Al substrate at velocities of 21.5 and 19.4 m/s, respectively. Microcapsules that maintain their structural integrity after hitting the target surface at 19.4 m/s can survive impacts from free fall down a 19.2 m (63 ft.) tall container. As shown in FIG. 6A, still higher impact velocities result in disintegration of the microcapsules. The safe impact velocity values of different modified bitumen microdroplets coated with a PDAC initial layer and sodium lignosulfonate and Ca(OH)₂ 3:2 (w/w) outer layer at 50° C. are shown in FIG. 7. The trends in safe impact velocities are fully consistent with the trends in stress-withstanding abilities across the three types of bitumen blends reported in FIGS. 5A-5B and are again directly correlated with their viscosities at 23° C. AB6 and PMB microcapsules stored at 50° C. for 7 days exhibit higher safe velocity values and increased resistance against impact because of the hardening of the shells at elevated temperatures (FIGS. 6A-6C). In contrast, there is no evident increase in the impact resistance for S45R microcapsules after being stored at 50° C. This is attributed to challenges in blending of rubber crumbs with bitumen; phase segregation of the additives results in inhomogeneous composition of the microdroplet cores. The inhomogeneities in composition result in distinctively weaker regions, which are prone to fracture despite hardening of the external shell at elevated temperatures.

We next turn our attention to modification of the bitumen binder rheological properties as they get transformed into microcapsules and evaluation of their viability for asphalt construction. Asphalt binders are generally heated to temperatures around 200° C. during mixing with gravel. FIG. 7 shows that as compared to virgin bitumen binders, incorporation of the solid shells somewhat increases the viscosity of the binder mixture. At a temperature of 130° C., the increase in viscosity is about 40-50% for AB6 and S45R, and ca. 120% for PMB Conc. At a temperature of 200° C., all the microencapsulated blends show a ca. 100% increase in their respective relative viscosities. In general, when an asphalt binder has a higher viscosity at high temperatures, it tends to produce a mix that can affords better structural strength and stiffness without undergoing significant shear deformation. As such, the microcapsules show excellent promise for direct implementation in practical applications.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated within the scope of the invention without limitation thereto.

### REFERENCES

(1) Polacco, G., Filippi, S., Merusi, F., Stastna, G. A review of the fundamentals of polymer-modified asphalts: Asphalt/polymer interactions and principles of compatibility. Advances in colloid and interface science 2015, 224, 72-112.
(2) Lewandowski, L. H. Polymer modification of paving asphalt binders. Rubber Chemistry and Technology 1994, 67 (3), 447-80.
(3) Yildirim, Y. Polymer modified asphalt binders. Construction and building materials 2007, 21(1). 66-72
(4) Bieliatynskyi, A.; Yang, S.; Pershakov, V.; Shao, M.; Ta, M. Study of Crushed Stone-Mastic Asphalt Concrete Using Fiber from Fly Ash of Thermal Power Plants. Case Stud. Constr. Mater. 2022, 16, e00877. See website: doi.org/10.1016/J.CSCM.2022.E00877.
(5) Caputo, P.; Abe, A. A.; Loise, V.; Porto, M.; Calandra, P.; Angelico, R.; Rossi, C. O. The Role of Additives in Warm Mix Asphalt Technology: An Insight into Their Mechanisms of Improving an Emerging Technology. Nanomater. 2020, 10 (6), 1202. See website: doi.org/10.3390/NANO10061202.
(6) Al Hawesah, H.; Sadique, M.; Harris, C.; Al Nageim, H.; Stopp, K.; Pearl, H.; Shubbar, A.; Harris@ljmu, C. B. A.; Uk, C. H.; Alnageim@ljmu, H. K. A.; Uk, H. A. N.; Shubbar@ljmu, A. A. A.; Uk, A. S. A Review on Improving Asphalt Pavement Service Life Using Gilsonite-Modified Bitumen. Sustain. 2021, 13 (12), 6634. See website: doi.org/10.3390/SU13126634.
(7) Zair, M. M. Ben; Jakarni, F. M.; Muniandy, R.; Hassim, S. A Brief Review: Application of Recycled Polyethylene Terephthalate in Asphalt Pavement Reinforcement. Sustain. 2021, 13 (3), 1303. See website: doi.org/10.3390/SU13031303.
(8) Choudhary, J.; Kumar, B.; Gupta, A. Utilization of Solid Waste Materials as Alternative Fillers in Asphalt Mixes: A Review. Constr. Build. Mater. 2020, 234, 117271. See website: doi.org/10.1016/J.CONBUILDMAT.2019.117271.
(9) Sun, G.; Zhang, J.; Tan, X.; Guo, D.; Zhou, Y.; Guan, Y. Evaluation of Conventional Technical Properties and Self-Healing Ability of Bitumen-Based Sealants Containing Sunflower-Oil Microcapsules for Pavement Cracks. Constr. Build. Mater. 2020, 254, 119299. See website: doi.org/10.1016/J.CONBUILDMAT.2020.119299.
(10) Brown, S. F.; Rowlett, R. D.; Boucher, J. L. Asphalt Modification. 1991, page 472. See website: doi.org/10.1680/HRSTB.16354.0017.
(11) Milad, A.; Babalghaith, A. M.; Al-Sabaeei, A. M.; Dulaimi, A.; Ali, A.; Reddy, S. S.; Bilema, M.; Yusoff, N. I. M. A Comparative Review of Hot and Warm Mix Asphalt Technologies from Environmental and Economic Perspectives: Towards a Sustainable Asphalt Pavement. Int. J. Environ. Res. Public Heal. 2022, 19 (22), 14863. See website: doi.org/10.3390/IJERPH192214863.
(12) Minhoto M J, Pais J C. Pereira P A. The temperature effect on the reflective cracking of asphalt overlays. Road materials and pavement design. 2008, 9 (4), 615-32.
(13) Freitas E, Pereira P, Picado-Santos L. Assessment of top-down cracking causes in asphalt pavements. In 3rd international symposium on maintenance and rehabilitation of pavements and technological control, Guimarães, Portugal 2003, 555-564.
(14) Isacsson, U.; Zeng, H. Cracking of Asphalt at Low Temperature as Related to Bitumen Rheology. J. Mater. Sci. 1998, 33 (8), 2165-2170. See website: doi.org/10.1023/A:1004383506240.
(15) Isacsson, U.; Zeng, H. Relationships between Bitumen Chemistry and Low Temperature Behaviour of Asphalt. Constr. Build. Mater. 1997, 11 (2), 83-91. See website: doi.org/10.1016/S0950-0618(97)00008-1.
(16) Abouelsaad, A.; White, G. Review of Asphalt Mixture Ravelling Mechanisms, Causes and Testing. Int. J. Pavement Res. Technol. 2021, 1-15. See website: doi.org/10.1007/S42947-021-00100-7.
(17) Zhang, X.; Hoff, I. Comparative Study of Thermal-Oxidative Aging and Salt Solution Performance. Mater. 2021, 14 (5), 1174. See website: Aging on Bitumen doi.org/10.3390/MA14051174.
(18) Li, J.; Xiao, X.; Chen, Z.; Xiao, F.; Amirkhanian, S. N. Internal De-Crosslinking of Scrap Tire Crumb Rubber to Improve Compatibility of Rubberized Asphalt. Sustain. Mater. Technol. 2022, 32, e00417. See website: doi.org/10.1016/J.SUSMAT.2022.E00417.
(19) Isacsson, U.; Lu, X. Characterization of Bitumens Modified with SEBS, EVA and EBA Polymers. J. Mater. Sci. 1999, 34 (15), 3737-3745. See website: doi.org/10.1023/A:1004636329521.
(20) Yildirim, Y. Polymer Modified Asphalt Binders. Constr. Build. Mater. 2007, 21 (1), 66-72. See website: doi.org/10.1016/J.CONBUILDMAT.2005.07.007.
(21) Polacco, G.; Filippi, S.; Merusi, F.; Stastna, G. A Review of the Fundamentals of Polymer-Modified Asphalts: Asphalt/Polymer Interactions and Principles of Compatibility. Adv. Colloid Interface Sci. 2015, 224, 72-112. See website: doi.org/10.1016/J.CIS.2015.07.010.
(22) Balaguera, A.; Carvajal, G. I.; Albertí, J.; Fullana-i-Palmer, P. Life Cycle Assessment of Road Construction Alternative Materials: A Literature Review. Resour. Conserv. Recycl. 2018, 132, 37-48. See website: doi.org/10.1016/J.RESCONREC.2018.01.003.
(23) Picado-Santos, L. G.; Capitão, S. D.; Neves, J. M. C. Crumb Rubber Asphalt Mixtures: A Literature Review. Constr. Build. Mater. 2020, 247, 118577. See website: doi.org/10.1016/J.CONBUILDMAT.2020.118577.
(24) Mohajerani, A.; Burnett, L.; Smith, J. V.; Markovski, S.; Rodwell, G.; Rahman, M. T.; Kurmus, H.; Mirzababaci, M.; Arulrajah, A.; Horpibulsuk, S.; Maghool, F. Recycling Waste Rubber Tyres in Construction Materials and Associated Environmental Considerations: A Review. Resour. Conserv. Recycl. 2020, 155. See website: doi.org/10.1016/J.RESCONREC.2020.104679.
(25) Ruan, Y.; Davison, R. R.; Glover, C. J. The Effect of Long-Term Oxidation on the Rheological Properties of Polymer Modified Asphalts. Fuel 2003, 82 (14), 1763-1773. Sec website: doi.org/10.1016/S0016-2361(03)00144-3.
(26) Yildirim, Y. Polymer Modified Asphalt Binders. Constr. Build. Mater. 2007, 21 (1), 66-72. See website: doi.org/10.1016/J.CONBUILDMAT.2005.07.007.
(27) Douglas, L. D.; Rivera-Gonzalez, N.; Cool, N.; Bajpayee, A.; Udayakantha, M.; Liu, G. W.; Anita; Banerjee, S. A Materials Science Perspective of Midstream Challenges in the Utilization of Heavy Crude Oil. ACS Omega 2022, 7 (2), 1547-1574. See website: doi.org/10.1021/ACSOMEGA.1C06399/ASSET/IMAGES/LARGE/AO1C06399_0014.JPE G.
(28) Navarro, F. J.; Partal, P.; Martínez-Boza, F.; Gallegos, C. Thermo-Rheological Behaviour and Storage Stability of Ground Tire Rubber-Modified Bitumens. Fuel 2004, 83 (14-15), 2041-2049. See website: doi.org/10.1016/J.FUEL.2004.04.003.
(29) Mouillet, V.; Lamontagne, J.; Durrieu, F.; Planche, J. P.; Lapalu, L. Infrared Microscopy Investigation of Oxidation and Phase Evolution in Bitumen Modified with Polymers. Fuel 2008, 87 (7), 1270-1280. See website: doi.org/10.1016/J.FUEL.2007.06.029.
(30) Mouillet, V.; Farcas, F.; Besson, S. Ageing by UV Radiation of an Elastomer Modified Bitumen. Fuel 2008, 87 (12), 2408-2419. See website: doi.org/10.1016/J.FUEL.2008.02.008.
(31) Xiaohu, L.; Isacsson, U. Chemical and Rheological Evaluation of Ageing Properties of SBS Polymer Modified Bitumens. Fuel 1998, 77 (9-10), 961-972. See website: doi.org/10.1016/S0016-2361(97)00283-4.
(32) Cong, P.; Wang, J.; Zhou, Z. Effects of Thermal Degradation on Polymer Modified Asphalt Binders during Storage and Transportation. Constr. Build. Mater. 2020, 248. See website: doi.org/10.1016/J.CONBUILDMAT.2020.118694.
(33) Douglas, L. D.; O'Loughlin, T. E.; Chalker, C. J.; Cool, N.; Gupta, S.; Batteas, J. D.; Banerjee, S. Three-Dimensional Inverse Opal TiO2 Coatings to Enable the Gliding of Viscous Oils. Energy and Fuels 2020, 34 (11), 13606-13613. See website: doi.org/10.1021/ACS.ENERGYFUELS.0C02031/ASSET/IMAGES/LARGE/EF0C02031_0006.JPEG.
(34) US20220135885A1—Mechanically resilient bitumen microcapsules for midstream transport—Google Patents See website: patents.google.com/patent/US20220135885A1/en (accessed Jun. 28, 2022).
(35) Anita; Zaheer, W.; Jakhar, K.; Antao, D. S.; Gupta, S.; Banerjee, S. Powder Bed Coating of Bitumen with Asphaltenes to Obtain Solid Prills for Midstream Transportation. Fuel 2021, 302. See website: doi.org/10.1016/j.fuel.2021.121093.
(36) Jyothi, N. V. N.; Prasanna, P. M.; Sakarkar, S. N.; Prabha, K. S.; Ramaiah, P. S.; Srawan, G. Y. Microencapsulation Techniques, Factors Influencing Encapsulation Efficiency. 2010, 27 (3), 187-197. See website: doi.org/10.3109/02652040903131301.
(37) Dubey R. Microencapsulation technology and applications. Defence Science Journal. 2009, 59 (1), 82.
(38) Anita; Zaheer, W.; Douglas, L.; Sellers, D. G.; Gupta, S.; Banerjee, S. Asphaltene Microencapsulation of Bitumen as a Means of Solid-Phase Transport. Energy and Fuels 2021, 35 (8), 6576-6584. (1) Polacco, G., Filippi, S., Merusi, F., Stastna, G. A review of the fundamentals of polymer-modified asphalts: Asphalt/polymer interactions and principles of compatibility. Advances in colloid and interface science 2015, 224, 72-112.
(39) Fink, J. K. Fluid Loss Additives. Pet. Eng. Guid. to Oil F. Chem. Fluids 2012, 61-123. See website: doi.org/10.1016/B978-0-12-383844-5.00002-7.
(40) Fatemi, S.; Bazaz, J. B.; Ziaee, S. A. Laboratory Investigation of Using Calcium Lignosulfonate as an Oxidation Inhibitor in Bitumen. Adv. Civ. Eng. 2022, 2022. See website: doi.org/10.1155/2022/1488958.
(41) Zhang, Y.; Wang, X.; Ji, G.; Fan, Z.; Guo, Y.; Gao, W.; Xin, L. Mechanical Performance Characterization of Lignin-Modified Asphalt Mixture. Appl. Sci. 2020, 10 (9), 3324. See website: doi.org/10.3390/APP10093,324.
(42) Dessbesell, L.; Palcologou, M.; Leitch, M.; Pulkki, R.; Xu, C. (Charles). Global Lignin Supply Overview and Kraft Lignin Potential as an Alternative for Petroleum-Based Polymers. Renew. Sustain. Energy Rev. 2020, 123, 109768. Sec website: doi.org/10.1016/J.RSER.2020.109768.
(43) Grajales, J. A.; Pérez, L. M.; Schwab, A. P.; Little, D. N. Quantum Chemical Modeling of the Effects of Hydrated Lime (Calcium Hydroxide) as a Filler in Bituminous Materials. ACS Omega 2021, 6 (4), 3130-3139.
(44) Little, D. N.; Petersen, J. C. Unique Effects of Hydrated Lime Filler on the Performance-Related Properties of Asphalt Cements: Physical and Chemical Interactions Revisited. J. Mater. Civ. Eng. 2005, 17 (2), 207-218. Sec website: doi.org/10.1061/(ASCE)0899-1561(2005)17:2(207).
(45) Lesueur, D.; Petit, J.; Ritter, H.-J.; Author, C.; Published); Francis, T. &. The Mechanisms of Hydrated Lime Modification of Asphalt Mixtures: A State-of-the-Art Review. 2013, 14 (1), 1-16. See website: doi.org/10.1080/14680629.2012.743669.
(46) Schneider, C. A.; Rasband, W. S.; Eliceiri, K. W. NIH Image to ImageJ: 25 Years of Image Analysis. Nat. Methods 2012, 9 (7), 671-675. See website: doi.org/10.1038/nmeth.2089.
(47) Anita; Zaheer, W.; Jakhar, K.; Antao, D. S.; Gupta, S.; Banerjee, S. Powder Bed Coating of Bitumen with Asphaltenes to Obtain Solid Prills for Midstream Transportation. Fuel 2021, 302, 121093. Sec website: doi.org/10.1016/J.FUEL.2021.121093.
(48) Anita; Zaheer, W.; Douglas, L.; Sellers, D. G.; Gupta, S.; Banerjee, S. Asphaltene Microencapsulation of Bitumen as a Means of Solid-Phase Transport. Energy & Fuels 2021, 35 (8), 6576-6584. See website: doi.org/10.1021/ACS.ENERGYFUELS.0C04305.
(49) Aldagari, S.; Kabir, S. F.; Fini, E. H. A Comparative Study on Efficacy of Waste Plastic and Waste Rubber in Bitumen. Constr. Build. Mater. 2022, 325. See website: doi.org/10.1016/J.CONBUILDMAT.2022.126724.
(50) Sill, T. E.; Zaheer, W.; Valdes, C. G.; Balcorta, V. H.; Douglas, L.; Fletcher, T.; Steiger, S.; Spinner, N. S.; Verkhoturov, S. V.; Kalyanaraman, V.; Verghese, N.; Pharr, M.; Sheth, K.; Davidson, R. D.; Banerjee, S. Mechanistic Origins of Corrosion Protection of Aluminum Alloys by Graphene/Polyetherimide Nanocomposite Coatings. npj Mater. Degrad. 2023, 7 (1), 1-13. Sec website: doi.org/10.1038/s41529-023-00349-2.
(51) Liang, Y.; Bai, T.; Zhou, X.; Wu, F.; Chenxin, C.; Peng, C.; Fuentes, L.; Walubita, L. F.; Li, W.; Wang, X. Assessing the Effects of Different Fillers and Moisture on Asphalt Mixtures' Mechanical Properties and Performance. Coatings 2023, 13 (2), 1-18. See website: doi.org/10.3390/coatings13020288.
(52) Zhou, H.; Yang, D.; Zhu, J. Y. Molecular Structure of Sodium Lignosulfonate from Different Sources and Their Properties as Dispersant of TiO2 Slurry. J. Dispers. Sci. Technol. 2016, 37 (2), 296-303. See website: doi.org/10.1080/01932691.2014.989572.
(53) Sun, L. Shear Strength Measurements for Asphalt Mixture. Struct. Behav. Asph. Pavements 2016, 715-795. See website: doi.org/10.1016/B978-0-12-849908-5.00011-0.

We claim:

1. A composition comprising a bitumen or a derivative thereof and a capsule surrounding the bitumen or the derivative thereof, wherein the capsule comprises a polyanionic electrolyte and a cationic polyelectrolyte.

2. The composition of claim 1, wherein the derivative of bitumen is a polymer-modified bitumen (PMB) or a rubber-modified bitumen (RMB).

3. The composition of claim 2, wherein the PMB comprises a styrene-butadiene-styrene (SBS) polymer.

4. The composition of claim 2, wherein the RMB comprises a non-vulcanized or vulcanized crumb rubber, natural rubber, desulphurized rubber, nitrile rubber, styrene butadiene rubber, butyl rubber, acryl rubber, fluoride rubber (as defined by ASTM International standard D1418), neoprene, fluorosilicone rubber, and/or polyisoprene.

5. The composition of claim 1, wherein the polyanionic electrolyte is an alkali lignin, alkaline lignin, and/or lignosulfate or salts thereof, such as a sodium, calcium, magnesium, and/or ammonium salt.

6. The composition of claim 5, wherein the polyanionic electrolyte is sodium lignosulfonate.

7. The composition of claim 1, wherein the cationic polyelectrolyte is poly(diallyl dimethylammonium chloride) (PDAC), Polyethyleneimine (PEI), Diethylaminoethyl-dextran (DEAE-dextran), Poly(amidoamine) (PAMAM) dendrimers; polyamidoamine, mannosylated PEI, a block copolymer containing cationic fragments of Poly(ethylene oxide)-block-poly(vinyl benzyl trimethylammonium chloride) or poly(2-methacryloyloxyethyl phosphorylcholine methacrylate)-block-poly(vinyl benzyl trimethylammonium chloride), or combinations thereof.

8. The composition of claim 1, wherein the capsule further comprises Ca(OH)₂, calcium oxide, magnesium hydroxide, magnesium oxide, barium hydroxide, barium oxide, strontium hydroxide, strontium oxide, baralyme (BaCaH₅KO₅), soda lime, oxides of silicon, aluminum, iron and calcium, pozzolans, fly ash, volcanic ash, pumice, opaline shales, burnt clay, or combinations thereof.

9. The composition of claim 1, wherein the capsule comprises at least one layer comprising a polyanionic electrolyte and at least one layer comprising a cationic polyelectrolyte.

10. A method of synthesizing an encapsulated bitumen, the method comprising:
a) providing a droplet of bitumen;
b) mixing the droplet of bitumen with a cationic polyelectrolyte; and
c) mixing the droplet of bitumen with a polyanionic electrolyte and Ca(OH)₂ to yield the encapsulated bitumen.

11. The method of claim 10, wherein the droplet of bitumen is a droplet of a polymer-modified bitumen (PMB) or a droplet of a rubber-modified bitumen (RMB).

12. The method of claim 11, wherein the PMB comprises a styrene-butadiene-styrene (SBS) polymer.

13. The method of claim 11, wherein the RMB comprises non-vulcanized or vulcanized crumb rubber, natural rubber, desulphurized rubber, nitrile rubber, styrene butadiene rubber, butyl rubber, acryl rubber, fluoride rubber (as defined by ASTM International standard D1418), neoprene, fluorosilicone rubber, and/or polyisoprene.

14. The method of claim 10, wherein the polyanionic electrolyte is an alkali lignin, alkaline lignin, and/or lignosulfate or salts thereof, such as a sodium, calcium, magnesium, and/or ammonium salt.

15. The method of claim 14, wherein the polyanionic electrolyte is sodium lignosulfonate.

16. The method of claim 10, wherein the cationic polyelectrolyte is PDAC Polyethyleneimine (PEI), Diethylaminoethyl-dextran (DEAE-dextran), Poly(amidoamine) (PAMAM) dendrimers; polyamidoamine, mannosylated PEI, a block copolymer containing cationic fragments of Poly(ethylene oxide)-block-poly(vinyl benzyl trimethylammonium chloride) or poly(2-methacryloyloxyethyl phosphorylcholine methacrylate)-block-poly(vinyl benzyl trimethylammonium chloride), or combinations thereof, optionally mixed with another material selected from the group consisting of Ca(OH)₂, calcium oxide, magnesium hydroxide, magnesium oxide, barium hydroxide, barium oxide, strontium hydroxide, strontium oxide, baralyme (BaCaH₅KO₅), soda lime, oxides of silicon, aluminum, iron and calcium, pozzolans, fly ash, volcanic ash, pumice, opaline shales, burnt clay, and combinations thereof.

17. The method of claim 10, further comprising:
d) agitating the encapsulated bitumen.

18. The method of claim 10, wherein the method is performed at a temperature of about 18° C. to about 80° C.

19. The method of claim 10, wherein the cationic polyelectrolyte is a liquid, the polyanionic electrolyte is a powder, and Ca(OH)₂ is a powder.

20. The method of claim 19, wherein step b) further comprises removing the droplet of bitumen from the cationic polyelectrolyte liquid before mixing the droplet of bitumen with the powder of the polyanionic electrolyte and the powder of Ca(OH)₂.
